(19) United States
(12) Patent Application Publication
(10) Pub. No.: US 2024/0145743 A1
(43) Pub. Date: May 2, 2024

(54) Fuel Supply Apparatus

(71) Applicant: Norgren Manufacturing Co., Ltd., Shanghai (CN)

(72) Inventors: Yi Liu, Shanghai (CN); Jing Cheng, Shanghai (CN); Yujie Bai, Shanghai (CN)

(21) Appl. No.: 18/549,485

(22) PCT Filed: Feb. 14, 2022
(86) PCT No.: PCT/CN2022/076145

§ 371 Date: Sep. 7, 2023

(30) Foreign Application Priority Data
Mar. 8, 2021 (WO) PCT/CN2021/079578
Apr. 8, 2021 (WO) PCT/CN2021/085955

(51) Int. Cl. H01M 8/04082; H01M 8/04007; H01M 8/04029; H01M 8/04089; H01M 8/04746

(52) U.S. Cl. CPC H01M 8/04201; H01M 8/04029; H01M 8/04037; H01M 8/04097; H01M 8/04753

(57) ABSTRACT

A fuel supply apparatus for a fuel cell system, the apparatus comprising a manifold unit comprising a body; a fuel supply flow path by which fuel is supplied to an inlet of said fuel cell system, the fuel supply flow path extending at least partly through the body of the manifold unit; a fuel recirculation flow path by which residual fuel is transferred from an outlet of said fuel cell system to the fuel supply flow path, the fuel recirculation flow path extending at least partly through the body of the manifold unit; at least one valve for controlling flow along the fuel supply flow path and/or the fuel recirculation flow path, wherein the at least one valve is integral to the body of the manifold unit; and a heating apparatus, wherein at least a heating portion of the heating apparatus is integral to the body of the manifold unit.

### TECHNICAL FIELD

The present disclosure relates to a fuel supply apparatus for a fuel cell system, and to a fuel cell system including a fuel supply apparatus.

### BACKGROUND

A typical fuel cell system is configured for use with fuel in the form of a gas such as hydrogen. In such a system, fuel is introduced to the system from a fuel storage tank via a supply manifold. The fuel then enters a fuel cell stack for the generation of electricity.

In order for the electricity-generating reaction to take place continuously, the pressure and flow rate of the fuel in the fuel cell stack must be controlled. Where the fuel is hydrogen, the hydrogen within the fuel cell stack must be refreshed in order to keep the hydrogen at a desired concentration. The fuel cell system typically and unavoidably includes water, so that ice can form when the temperature is lower than a certain point. Commonly, ice can form when the temperature drops below 4° C. Ice can prevent movement of moving parts within the fuel cell system. This is a particular problem when the fuel cell stack is started at a low temperature, known as a cold start.

Not all of the fuel supplied to the fuel cell stack is consumed in the generation of electricity. Such residual fuel is removed from the fuel cell stack, and can be recirculated within the system in order to avoid waste.

When the ambient temperature is low, hydrogen within the fuel storage tank is at a similarly low temperature. Relatively cold hydrogen from the fuel storage tank passes through the supply manifold and mixes with recirculated residual fuel from the fuel cell stack. This recirculated residual fuel is of relatively high humidity and high temperature, e.g. approximately 70-85° C. As the cold fuel from the storage tank meets the higher temperature recirculated fuel, condensation occurs, so that there is the risk of an excessive level of water within the fuel that could cause a decrease in the performance of the fuel cell stack.

A supply manifold that includes a recirculation system for residual fuel from the fuel cell stack typically contains a number of moving parts such as valves, e.g. shut-off valves for isolating fuel from the fuel storage tank and to control the flow of fuel through the supply manifold. Icing is therefore a particular concern in such arrangements.

It is known to use a heater such as a positive temperature coefficient (PTC) heater to directly heat a specific component such as a single valve. However, where a supply manifold includes multiple moving parts such as valves, multiple heaters will be required, leading to increased complexity of the system.

The present arrangement aims to address one or more of the above problems.

### SUMMARY OF THE INVENTION

Aspects and embodiments of the invention provide a fuel supply apparatus for a fuel cell system, the apparatus comprising a manifold unit comprising a body; a fuel supply flow path by which fuel is supplied to an inlet of said fuel cell system, the fuel supply flow path extending at least partly through the body of the manifold unit; a fuel recirculation flow path by which residual fuel is transferred from an outlet of said fuel cell system to the fuel supply flow path, the fuel recirculation flow path extending at least partly through the body of the manifold unit; at least one valve for controlling flow along the fuel supply flow path and/or the fuel recirculation flow path, wherein the at least one valve is integral to the body of the manifold unit; and a heating apparatus, wherein at least a heating portion of the heating apparatus is integral to the body of the manifold unit.

Providing a heating apparatus having at least a heating portion of the heating apparatus integral to the manifold unit body advantageously allows heating of components held within the manifold unit, such as one of or each valve, and/or the fuel supply flow path. Icing of moving parts such as one of or each valve is thus inhibited. Fuel within the fuel supply flow path can be heated, reducing condensation created when fuel of the fuel supply flow path meets recirculated fuel.

In exemplary embodiments, the heating apparatus is configured for heating the body of the manifold unit.

Heating the body provides the simultaneous benefit of decreasing icing up of moving parts such as valves and reducing condensation. Indirect heating of valves allows a single system to be used to heat multiple valves or other components of the fuel supply apparatus, rather than multiple heating systems, advantageously simplifying the system.

In exemplary embodiments, the heating apparatus comprises a coolant flow path, and the coolant flow path extends at least partly through the body of the manifold unit.

Using heated coolant to increase the temperature of the body is a simple and effective means of heating the body.

In exemplary embodiments, the body of the manifold unit comprises two or more separable parts, and the coolant flow path extends through both or each separable part of the body of the manifold unit.

The coolant flow path extending through all parts of the manifold unit allows heat to be efficiently spread through the manifold unit.

In exemplary embodiments, the body of the manifold unit is substantially of a metallic material.

In exemplary embodiments, the body of the manifold unit is substantially of aluminium.

In exemplary embodiments, the body of the manifold unit is substantially of stainless steel.

The body of the manifold unit being of a material of relatively high thermal conductivity, such as a metallic material e.g. aluminium or steel, aids the transfer of heat from the coolant flow path to the components of the fuel supply apparatus.

In exemplary embodiments, the fuel supply apparatus comprises a first valve for controlling flow of the fuel supply flow path, and a second valve for controlling flow of the fuel recirculation flow path.

The heating apparatus allows multiple valves to be used in the fuel supply system with a decreased likelihood of icing of those valves.

In exemplary embodiments, the first and second valves are integral to one another.

The heating apparatus allows different valve configurations without the need for custom heaters for each valve.

In exemplary embodiments, the fuel supply apparatus comprises a first ejector for introducing recirculated fuel from the fuel recirculation flow path to the fuel supply flow path.

The heating apparatus provides a decreased likelihood of icing in a fuel supply apparatus with an ejector for introducing recirculated fuel.

In exemplary embodiments, the fuel supply flow path comprises a first branch, and a second branch arranged in parallel to the first branch; wherein the fuel recirculation flow path comprises a first branch and a second branch; wherein the fuel supply apparatus comprises a first ejector for introducing recirculated fuel from the first branch of the fuel recirculation flow path to the first branch of the fuel supply flow path; a second ejector for introducing recirculated fuel from the second branch of the fuel recirculation flow path to the second branch of the fuel supply flow path; and a first valve for controlling flow at the second branch of the fuel supply flow path, and a second valve for controlling flow at the second branch of the fuel recirculation flow path.

Advantageously, the cost of the fuel supply apparatus is reduced by the use of ejectors rather than a pump in the recirculation of residual fuel, and the complexity of the apparatus is reduced. Recirculation performance is improved by the use of the second ejector only when required, i.e. when the fuel cell system is operated at a higher power rate. The second ejector can be isolated from the apparatus by the first and second valves. Decreased likelihood of icing is particularly advantageous in such a fuel supply apparatus, i.e. with efficient fuel recirculation and the associated multiple valves.

In exemplary embodiments, the first and second valves each have a first, closed position where flow is prevented and a second, open position where flow is permitted; wherein, when said fuel cell system is operated at a first, lower, power rate, the first and second valves are in the first, closed position, such that the introduction of recirculated fuel to the second branch of the fuel supply flow path at the second ejector is prevented; and when said fuel cell system is operated at a second, higher, power rate, the first and second valves are in the second, open position, such that recirculated fuel is introduced to the second branch of the fuel supply flow path at the second ejector.

Again, the decreased likelihood of icing that is provided by the heating apparatus is particularly advantageous in such a fuel supply apparatus, i.e. with efficient fuel recirculation and the associated multiple valves.

In exemplary embodiments, the fuel supply flow path comprises a proportional valve, and the proportional valve is integral to the body of the manifold unit.

In exemplary embodiments, the fuel supply flow path comprises a control system, wherein the control system is configured to provide closed loop control of the proportional valve.

In exemplary embodiments, the fuel supply flow path comprises a third branch arranged in parallel to the first and second branches, wherein the fuel recirculation flow path comprises a third branch, and wherein the fuel supply apparatus further comprises a third ejector for introducing recirculated fuel from the third branch of the fuel recirculation flow path to the third branch of the fuel supply flow path; a third valve for controlling flow at the third branch of the fuel supply flow path, and a fourth valve for controlling flow at the third branch of the fuel recirculation flow path, wherein the third and fourth valves each have a first, closed position where flow is prevented and a second, open position where flow is permitted; wherein, when said fuel cell system is operated at the first, lower, power rate, the third and fourth valves are in the first, closed position, such that the introduction of recirculated fuel to the third branch of the fuel supply flow path at the third ejector is prevented; when said fuel cell system is operated at the second, higher, power rate, the third and fourth valves are in the first, closed position, such that the introduction of recirculated fuel to the third branch of the fuel supply flow path at the third ejector is prevented; and when said fuel cell system is operated at a third power rate, higher than the first power rate, the third and fourth valves are in the second, open position, such that recirculated fuel is introduced to the third branch of the fuel supply flow path at the third ejector.

In exemplary embodiments, the or each valve is one of a non-return valve and a 2/2-way valve.

In exemplary embodiments, the fuel supply apparatus further comprises a valve for controlling flow at the first branch of the fuel recirculation flow path.

In exemplary embodiments, the valve for controlling flow at the first branch of the fuel recirculation flow path is a non-return valve.

There is also provided a fuel cell system comprising a fuel cell stack and a fuel supply apparatus as set out above.

In exemplary embodiments, the fuel cell system further comprises a heating system for heating the fuel cell stack, wherein the heating system comprises a heat source, and wherein the heating apparatus is configured to obtain heat from the heat source.

In exemplary embodiments, the heating system comprises a first coolant flow path, and the heating apparatus comprises a second coolant flow path. The second coolant flow path is in fluid communication with the first coolant flow path.

Advantageously, no additional heater is required to heat the fuel supply apparatus.

### BRIEF DESCRIPTION OF THE DRAWINGS

One or more embodiments will now be described, by way of example only, with reference to the accompanying drawings, in which:

FIG. 1 is a circuit diagram of a fuel supply apparatus for a fuel cell system according to the present teachings;

FIG. 2 is a perspective view of the fuel supply apparatus of FIG. 1;

FIG. 3 is a further perspective view of the fuel supply apparatus of FIGS. 1 and 2;

FIG. 4 is an exploded view of the fuel supply apparatus of FIGS. 2 and 3;

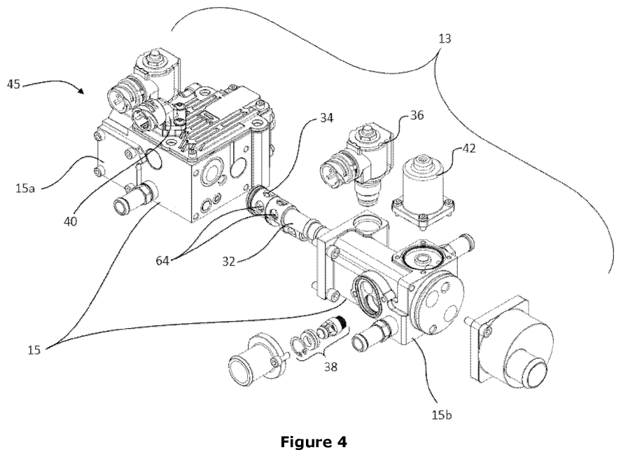

FIG. 5 is a cross-sectional view through the fuel supply apparatus of FIGS. 1 to 4;

FIG. 6 is a perspective view of a further fuel supply apparatus according to the present teachings;

FIG. 7 is a further perspective view of a fuel supply apparatus of FIG. 6; and

FIG. 8 is an exploded view of the fuel supply apparatus of FIGS. 6 and 7.

### DETAILED DESCRIPTION

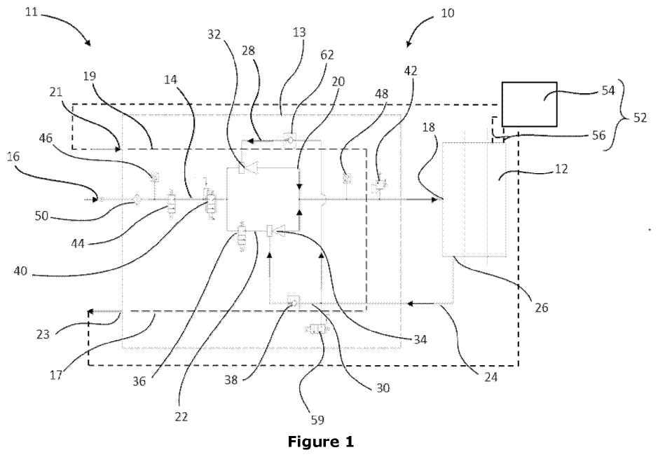

The circuit diagram of FIG. 1 shows a fuel supply apparatus for a fuel cell system 11 indicated generally at 10. The fuel used in the described fuel cell system is in the form of hydrogen supplied as a gas. However, the fuel supply apparatus is suitable for or can be adapted for other types of fuel cell.

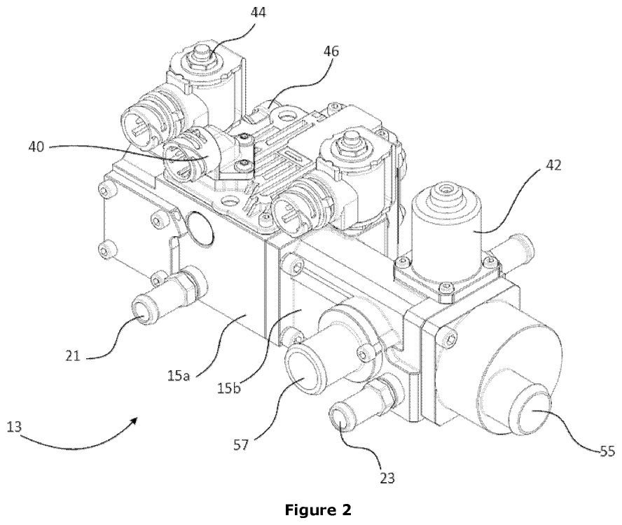

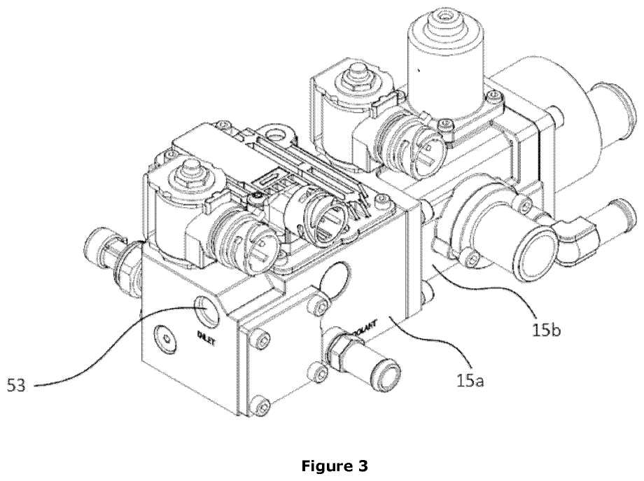

The fuel supply apparatus has a manifold unit 13, shown in FIGS. 2 and 3. The manifold unit 13 has a housing or body 15. Multiple component parts of the fuel supply apparatus described below are attached to or held within, the body 15. The manifold unit 13 is modular, i.e. component parts of the fuel supply apparatus 10 are supplied, or can be supplied, attached to or contained within the body 15. The fuel supply apparatus 10 is therefore quick and simple to install.

The fuel supply apparatus 10 has a fuel supply path 14. Fuel enters the fuel supply apparatus 10 from a fuel storage tank 16 and passes along the fuel supply flow path 14 to an inlet 18 of a fuel cell stack 12. In this embodiment, the fuel cell stack is in the form of a hydrogen cell stack 12.

The fuel supply apparatus 10 has a fuel recirculation flow path 24 for the transfer of residual fuel from an outlet 26 of the hydrogen cell stack 12. Residual fuel from the hydrogen cell stack 12 is introduced to the fuel supply flow path 14 and so returns to the inlet 18 of the hydrogen cell stack 12, reducing waste.

The fuel supply apparatus 10 includes at least one valve 36, 38 for controlling flow along the fuel supply flow path 14 and/or the fuel recirculation flow path 24. The or each valve 36, 38 is integral to the body 15. That is, the or each valve 36, 38 is attached to and extends at least partially within the body 15.

In this embodiment, the fuel supply flow path 14 has a first branch 20 and a second branch 22 arranged in parallel to one another.

In this embodiment, the fuel recirculation flow path 24 has a first branch 28 and a second branch 30. The first branch 28 is arranged to introduce recirculated fuel to the first branch 28 of the fuel supply flow path 14. The second branch 30 of the fuel recirculation flow path 24 is arranged to introduce recirculated fuel to the second branch 22 of the fuel supply flow path 14.

In this embodiment, the fuel supply apparatus 10 has a first valve 36 for controlling flow of the second branch 22 of the fuel supply flow path and a second valve 38 for controlling flow of the second branch 30 of the fuel recirculation flow path.

In this embodiment, the first valve 36 is a 2/2-way valve. In this embodiment, the second valve 38 is a check or non-return valve. In alternative embodiments, other suitable valves are used. For example, in one embodiment, the second valve is a 2/2-way valve.

In this embodiment, the fuel supply apparatus 10 includes a third valve 62 in the first branch 28 of the fuel recirculation path 24.

In this embodiment the third valve 62 is a non-return valve. In this embodiment, the third valve 62 prevents flow along the third branch 28 of the fuel recirculation path 24 in the unwanted direction, i.e. towards the fuel cell stack 12, whilst allowing flow in a desired direction. In an alternative embodiment, the third valve is some other suitable type of valve, such as a 2/2-way solenoid valve.

The third valve 62 is, like the first 36 and second 38 valves, integral to the body 15. That is, the third valve 62 is attached to the body 15, and extends at least partly within the body 15.

In an alternative embodiment, the fuel supply apparatus 10 has only first and second valves 36, 38, with no third valve.

The fuel supply apparatus 10 has a heating apparatus 17. The heating apparatus includes a heating portion 19 by which heat is provided. At least part of the heating portion 19 is integral to the manifold unit body 15, i.e. at least part of the heating portion 19 extends within the body 15.

Providing a heating apparatus with a heating portion 19 at least partly integral to the body 15 allows components of the fuel supply apparatus 10 that are integral to the body 15 to be heated by the heating apparatus 17. Icing of those components is therefore inhibited, so that those components that are moving components are less likely to have their movement inhibited due to icing.

The fuel supply flow path 14 can also be heated, as it extends at least partly through the body 15. That is, the part of the fuel supply flow path that is integral to the body 15 can be heated by the heating apparatus 17. The temperature of fuel within the fuel supply flow path 14 is thus increased, so that the temperature difference between fuel within the fuel supply flow path 14 and recirculated fuel is decreased, so advantageously decreasing the likelihood of condensation.

In this embodiment, the heating apparatus 17 is arranged such that the body 15 is heated. Heating the body 15 allows heat to be transferred to those components that are integral to the body 15 via a single heating apparatus. Components such as the first, second and third valves 36, 38, 62 are indirectly heated by the heating portion 19. In addition, fuel within the fuel supply flow path 14 is heated as it passes through the body 15. In this way, a single heating apparatus 17 is used to address both the problem of icing, and the problem of condensation that leads to icing. Advantageously, a single heat source is used. Such an arrangement is less complex than solutions such as heating individual valves. Nor does heating individual valves provide heat to fuel within the fuel supply flow path 14, to simultaneously and advantageously reduce condensation and so reduce the likelihood of icing by two methods.

The manifold unit 13 of this embodiment is substantially of metallic material. That is, the body 15 of this embodiment is substantially of metallic material. That is, a majority of the body 15 is of metallic material. In one embodiment, the body 15 is cast from a metallic material.

As metallic materials have relatively high thermal conductivity, the body 15 being of metallic material facilitates the conduction of heat from the heating apparatus 17 to components of the fuel supply apparatus 10. In this embodiment, the body 15 is substantially of aluminium. In an alternative embodiment, the body 15 is substantially of stainless steel. In alternative embodiments, the body is substantially of some other suitable material, i.e. a metallic or non-metallic material with thermal conductivity that allows a suitable rate of transfer of heat from the heating apparatus 17 to the components of the fuel supply apparatus 10.

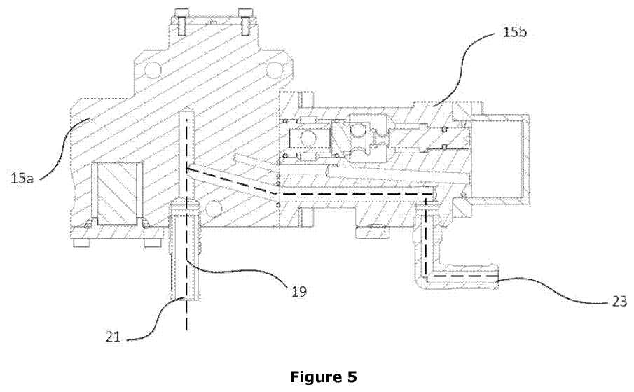

In this embodiment, the heating portion is in the form of a coolant flow path 19. As shown in FIG. 5, the manifold unit 13 has a coolant inlet 21 and a coolant outlet 23. Between the coolant inlet 21 and the coolant outlet 23, the heating portion forms a coolant flow path 19 through the body 15. In this embodiment, the coolant flow path 19 has a diameter in the range of 6 mm to 10 mm. In alternative embodiments, the coolant flow path is of some other suitable diameter range.

In this embodiment, the heating portion is in the form of a single coolant flow path 19, i.e. a coolant flow path with a single coolant inlet and a single coolant outlet. In an alternative embodiment, the heating portion includes two or more coolant flow paths, and/or multiple coolant inlets and/or multiple coolant outlets.

Coolant is heated before entering the body 15 at the coolant inlet 21. The fuel cell stack 12 has a heating system 52 in order to address cold start issues within the fuel cell stack 12 (see FIG. 1). The fuel cell stack heating system typically includes a heater 54, and a coolant flow path 56 for transporting coolant between the heater 54 and the fuel cell stack 12. In this embodiment, the heater is a PTC heater 54. In this embodiment, the heating apparatus 17 is provided with heat from the same source as the fuel cell stack heating system, i.e. from the PTC heater 54. In this embodiment, the coolant flow path 19 is connected to (i.e. is in fluid communication with) the coolant flow path 56, so that heated coolant from the fuel cell stack heating system 52 is supplied to the coolant flow path 19. Advantageously, no separate nor additional form of heater is required in order to heat the fuel supply apparatus, so that the fuel supply apparatus 10 is simplified.

No additional heater is required, simplifying the fuel supply apparatus 10.

In alternative embodiments, coolant for the coolant flow path 19 is heated separately by some other means, e.g. by a separate PTC heater.

As the heated coolant flows along the coolant flow path 19 through the body 15, heat is transferred from the coolant to the body 15. The temperature of the body 15 is thereby increased. As the temperature of the body 15 increases, heat is transferred from the body to the components of the fuel supply apparatus 10 that are integral to the manifold unit 13, e.g. to the first, second and/or third valves 36, 38, 62. Heat is also transferred from the body 15 to fuel within the fuel supply path 14, as described above.

In order to efficiently recirculate residual fuel, in this embodiment, an ejector 32, 34 is provided at each of the first and second branches 20, 22 of the fuel supply flow path in order to allow the introduction of residual fuel to the fuel supply flow path 14. A first ejector 32 is provided on the first branch 20 of the fuel supply path, and a second ejector 34 is provided on the second branch 22 of the fuel supply flow path. Recirculation of residual fuel can thus advantageously take place without the need of a pump, reducing the complexity and the cost of the fuel supply apparatus 10.

In this embodiment, when the fuel supply apparatus 10 is active, and fuel is transferred from the storage tank 16 to the fuel cell inlet 18 via the fuel supply flow path 14, the first branch 20 of the fuel supply flow path is constantly in use, i.e. fuel can pass along the fuel supply flow path 14 via the first branch 20 thereof. Similarly, when the fuel supply apparatus 10 is active, the first branch 28 of the fuel recirculation flow path is constantly open, and is used for the introduction of residual fuel to the fuel supply flow path 14.

As the first branch 20 of the fuel supply flow path is constantly in use when the fuel supply apparatus 10 is active, and the first ejector 32 is therefore always functional, there is no significant backflow along the first branch 28 of the fuel recirculation flow path, so that some embodiments do not have a valve 62. In embodiments where it is an important requirement to avoid backflow along the first branch 28 of the fuel recirculation flow path, the valve 62 is included.

As described above, the first and second valves 36, 38 are used for controlling flow of the second branch 22 of the fuel supply flow path and the second branch 30 of the fuel recirculation flow path respectively. As a 2/2-way valve, the first valve 36 has a first, closed position where flow is prevented, and a second, open position, where flow is permitted. The non-return second valve 38 prevents flow along the second branch 30 of the fuel recirculation path 24 in the unwanted direction, i.e. towards the fuel cell stack 12, whilst allowing flow in the desired direction, i.e. towards the second ejector 34.

Flow along the second branch 22 of the fuel supply path 14 is controlled by the first valve 36, so that there is no need to prevent flow along the second branch 30 of the fuel recirculation path 24 towards the second ejector 34. Using a non-return valve 38 increases simplicity of control of the fuel supply apparatus 10 and reduces the power required for operation of the apparatus 10, as no electricity is required to open or close the non-return valve 38.

When the fuel cell stack 12 is operated at a predetermined lower power rate, no recirculation of fuel through the second branch 30 of the fuel recirculation flow path is required. The valves 36, 38 are in a closed position, such that the second ejector 34 is isolated from the circuit—the flow of fuel along the second branch 30 of the fuel recirculation flow path and the second branch 22 of the fuel supply flow path is prevented. Fuel supply and fuel recirculation is carried out through the first branches 20, 28 alone.

In this embodiment, the first valve 36 is positioned upstream of the second ejector 34 on the second branch of the fuel supply flow path 14. Advantageously, positioning the first valve 36 upstream of the second ejector 34 avoids potential restriction of flow downstream of the second ejector 34. Flexibility of design choice of the first valve 36 is provided, as the orifice size of the first valve 36 in relation to the properties of the second ejector 34 need not be taken into consideration. In alternative embodiments, the first valve of the second branch of the fuel supply flow path is positioned downstream of the second ejector.

When the fuel cell stack 12 is operating at said predetermined lower power rate, this route is sufficient for the recirculation of residual fuel to the fuel supply flow path 14. However, when the fuel cell stack 12 is operated at a predetermined higher power rate, the fuel requirement of the fuel cell stack 12 is increased, as is the amount of residual fuel expelled from the fuel cell stack 12, so that the flow requirement of the fuel supply apparatus 10 is increased.

At such a time, the valves 36, 38 are moved to an open position, so that the second ejector 34 is no longer isolated from the circuit. Fuel can then flow along the second branch 22 of the fuel supply path 14 as well as the first branch 20 to reach the fuel cell stack inlet 18. Fuel can flow along the second branch 30 of the fuel recirculation flow path 24 as well as via the first branch 28, to reach the fuel supply path 14 via the respective ejectors 32, 34. Both of the ejectors 32, 34 are in use, and fuel flow rate (of both fuel supply and fuel recirculation) is thus increased. Advantageously, the increase in fuel flow rate is carried out simply, by the operation of the valves 36, 38.

The third valve 62 prevents the first and second ejectors 32, 34 affecting one another when both ejectors 32, 34 are in use.

In alternative embodiments, the first and second valves are integral to one another. That is, a single valve is used to shut off and open the second branches of the fuel supply and fuel recirculation flow paths, so that the second ejector can be isolated from the circuit by operation of a single valve. In one embodiment, the single valve is a 4/2-way valve where, in a first position, all four ports are blocked and flow through the valve in any direction is prevented. In a second position, all ports are open, and flow through the valve is permitted.

The fuel supply flow path 14 has a proportional valve 40 upstream of the division of the fuel supply flow path 14 into first and second branches 20, 22. The fuel supply apparatus has a control system 45 for controlling flow via the proportional valve 40. In this embodiment, the control system 45 uses CAN communication to operate the proportional valve 40 using closed loop control. Using closed loop control enables precision control of the proportional valve 40, and advantageously reduces hysteresis. Linearity error is also reduced, i.e. the difference between the output value in test data and the ideal data at a particular command signal is reduced.

In this embodiment, the proportional valve 40 has an integral pressure sensor (not shown).

In alternative embodiments, the proportional valve is positioned elsewhere in the fuel supply apparatus, or outside the fuel supply apparatus.

The fuel supply apparatus 10 also has a pressure relief valve 42. The pressure relief valve 42 is in this embodiment located on the fuel supply flow path 14. In this embodiment the pressure relief valve 42 is located downstream of the division of the fuel supply flow path into first and second branches 20, 22. In alternative embodiments, the pressure relief valve is located elsewhere in the fuel supply apparatus 10.

The fuel supply apparatus 10 has a 2/2-way operating valve 44 located on the fuel supply flow path 14 upstream of the division of the fuel supply flow path into first and second branches 20, 22. The operating valve 44 is moveable between open and closed positions corresponding to activation or deactivation of the fuel supply apparatus 10, i.e. when the operating valve 44 is in a closed position, the fuel supply apparatus 10 is non-operational. When the operating valve 44 is in an open position, the fuel supply apparatus 10 is operational, and fuel is supplied to the fuel cell stack 12 from the fuel storage tank 16 via the fuel supply flow path 14. In this embodiment, the operating valve 44 is in the form of a solenoid valve 44. In alternative embodiments, alternative suitable valves are used.

The fuel supply apparatus has first 46 and second 48 pressure sensors on the fuel supply flow path 14. The first pressure sensor is upstream of the operating valve 44, and so detects the pressure of fuel entering the fuel supply apparatus 10 from the fuel storage tank 16. The second pressure sensor 48 is downstream of the first and second branches 20, 22. The second pressure sensor thus detects the fuel pressure before the fuel reaches the inlet 18 of the fuel cell stack 12.

The fuel supply apparatus 10 has a filter 50 for filtering fuel as it enters the fuel supply apparatus 10 from the fuel storage tank 16. To this end, the filter 50 is positioned on the fuel supply flow path 14 upstream of the operating valve 44. In this embodiment, the first pressure sensor 46 is downstream of the filter 50.

With reference to FIGS. 2 and 3, fuel from the fuel storage tank 16 enters the manifold unit 13 at an inlet port 53, within which the filter 50 is supported. Fuel leaves the manifold unit 13 at an outlet port 55, before reaching the inlet 18 of the fuel cell stack 12 (see FIG. 1). Residual recirculated fuel expelled from the fuel cell stack 12 enters the manifold unit 13 at a recirculation port 57.

In this embodiment, the first and second ejectors 32, 34, the first and second valves 36, 38 and the proportional valve 40, together with the control system 45, are integral to the manifold unit 13. That is, those components are supported on, secured to and/or held within the body 15 of the manifold unit 13.

As shown in FIGS. 2 and 3, in this embodiment, the body 15 of the manifold unit 17 is made up of two separable portions 15a, 15b, i.e. separate portions that are attachable to one another to create the body 15. Each portion 15a, 15b defines apertures configured to receive components of the fuel supply apparatus. One portion 15b defines receiving portions configured to receive the ejectors 32, 34 such that the ejectors 32, 34 are held within the body 15. The portions 15a, 15b define projections and corresponding location apertures for easy and quick assembly. In alternative embodiments, the body 15 of the manifold unit 13 is made up of fewer than, or more than, two portions.

The coolant flow path 19 extends through both portions 15a, 15b, such that both portions 15a, 15b are heated by the heated coolant. Components received in both portions 15a, 15b are thus heated.

In this embodiment, the operating valve 44, the pressure sensors 46, 48, the filter 50 and the pressure relief valve 42 are also incorporated within the manifold unit 13. In alternative embodiments, one or more of the operating valve, the pressure sensors, the relief valve and the filter are located elsewhere in the fuel cell system, rather than in the manifold unit.

The first and second ejectors 32, 34 of this embodiment are of the same design. That is, the first and second ejectors are identical to one another, and have identical flow capacity. In alternative embodiments, the first and second ejectors are substantially identical to one another, and have substantially identical flow capacity. The use of the ejectors in parallel in response to the fuel cell stack operating a said higher power allows such identical components to be used—the fuel flow rate of the fuel supply apparatus is increased with the use of multiple ejectors, rather than ejectors of difference size/capacity. The nozzle dimensions of the first and second ejectors 32, 34 can be the same.

In this embodiment, each of the first and second ejectors 32, 34 are single stage ejectors. Each of the first and second ejectors 32, 34 has a first set of suction ports 64 arranged around the perimeter of the ejector 32, 34 by which recirculated fuel enters each ejector 32, 34.

The number of different components used in the flow supply apparatus 10 is therefore reduced, so reducing the complexity of assembly, as either ejector can be fitted in either position.

In alternative embodiments, as described in further detail below, the first and second ejectors are different to one another.

Although in the described embodiments first and second ejectors are provided, it is possible to adjust the fuel flow rate of the fuel supply apparatus by including further ejectors and related valves for isolating said ejector from the circuit. For example, in one embodiment, a third ejector is provided. In such an embodiment, the fuel supply flow path has a third branch, and the fuel recirculation flow path has a third branch, such that residual fuel can be recirculated from the fuel cell stack outlet to the fuel supply flow path via three ejectors simultaneously, or via two ejectors (either the first and third ejector or the first and second ejector) simultaneously, or by the first ejector alone as described above. An even greater range of fuel flow rate is thus provided. In such an embodiment, the third ejector can again be identical, or substantially identical, to the first and second ejectors.

In this embodiment, the first valve 36 and the operating valve 44 are solenoid valves. In alternative embodiments, the valves are some other suitable valve type, e.g. electric ball valves, direct poppet valves, or spool valves).

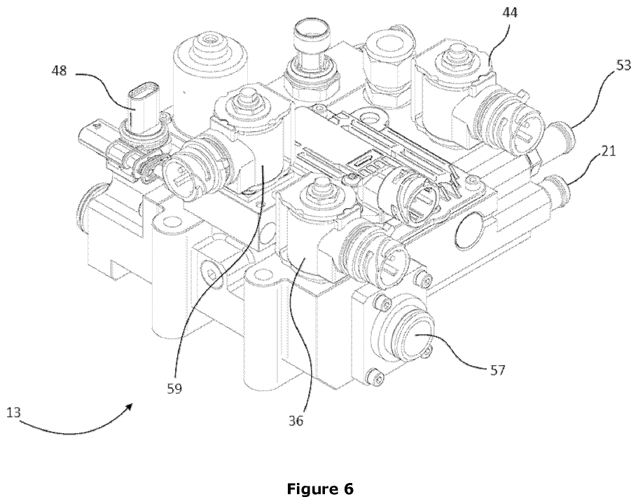

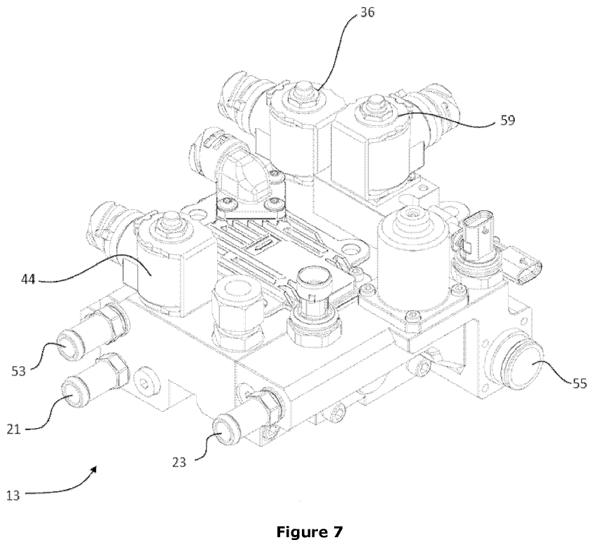

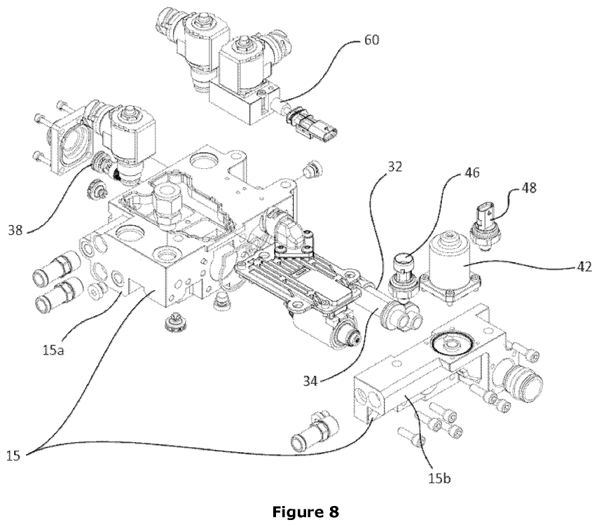

FIGS. 6 to 8 show a manifold unit 13 of an alternative layout. The first and second ejectors 32, 34, the first and second valves 36, 38 and the proportional valve 40, together with the control system 45, are again incorporated in the manifold unit 13. In this embodiment, the operating valve 44, the pressure sensors 46, 48, the filter 50 and the pressure relief valve 42 are also incorporated within the manifold unit 13. In alternative embodiments, one or more of the operating valve, the pressure sensors, the relief valve and the filter are located elsewhere in the fuel cell system, rather than in the manifold unit. As in the previous embodiment, the fuel supply apparatus 10 can be quickly and easily installed.

The fuel supply apparatus 10 of this embodiment has a purge valve 59. The purge valve 59 has an integral PTC heater. In alternative embodiments, the purge valve does not have a heater.

The layout of the manifold unit can be adjusted in multiple ways to suit the particular application of the fuel supply apparatus. Likewise, the ejector design can be altered, e.g. the nozzle diameter can be altered, depending on the fuel flow rate requirements of the fuel supply apparatus and the pressure ranges involved. In alternative embodiments, the nozzle dimensions of the first and second ejectors are different to one another, in order to meet required fuel power requirements. That is, the first and second ejectors are of different flow capacity.

The control of the fuel supply apparatus can be adjusted to suit particular applications using the control system 45.

In alternative embodiments, one or both of the ejectors is a multi-stage ejector with multiple sets of suction ports by which recirculated fuel enters the ejector. The inclusion of a multi-stage ejector, e.g. a two-stage ejector, or a three-stage ejector, can advantageously increase suction efficiency. In an alternative embodiment, the fuel supply apparatus has ejectors of different numbers of multiple stages, e.g. a two-stage ejector and a three-stage ejector. In alternative embodiments (not shown), the fuel supply apparatus has identical or substantially identical multi-stage ejectors with substantially identical flow capacity. In one alternative embodiment, the fuel supply apparatus has two two-stage ejectors. In one alternative embodiment, the fuel supply apparatus has two three-stage ejectors. In an embodiment with more than two ejectors, the fuel supply apparatus has a combination of ejectors with different numbers of stages, or the fuel supply apparatus has ejectors of the same number of stages.

The fuel supply apparatus above described provides a decreased likelihood of icing, as well as precision control of recirculation of residual fuel. Multiple components of the fuel supply apparatus are incorporated into a single modular unit, improving the ease of installation. The ejectors are in an arrangement that allows them to be simply controlled to meet different flow rate requirements of the fuel cell system, i.e. depending on the power consumption of the fuel cell stack. Isolation of the second ejector can be simply achieved using the 2/2-way valves, or the 2/2-way valve and the non-return valve.

Hysteresis and the linearity problem of the flow curve is addressed using closed loop control. Overall stability and safety of the system is improved by the control system and proportional valve. The compatibility of the system with various applications is improved by the modular manifold unit arrangement.

1. A fuel supply apparatus for a fuel cell system, the fuel supply apparatus comprising:
a manifold unit comprising a body;
a fuel supply flow path by which fuel is supplied to an inlet of said fuel cell system, the fuel supply flow path extending at least partly through the body of the manifold unit;
a fuel recirculation flow path by which residual fuel is transferred from an outlet of said fuel cell system to the fuel supply flow path, the fuel recirculation flow path extending at least partly through the body of the manifold unit;
at least one valve for controlling flow along the fuel supply flow path or the fuel recirculation flow path, wherein the at least one valve is integral to the body of the manifold unit; and
a heating apparatus, wherein at least a heating portion of the heating apparatus is integral to the body of the manifold unit.

2. The fuel supply apparatus of claim 1, wherein the heating apparatus is configured for heating the body of the manifold unit.

3. The fuel supply apparatus of claim 1, wherein the heating apparatus comprises a coolant flow path, and wherein the coolant flow path extends at least partly through the body of the manifold unit.

4. The fuel supply apparatus of claim 3, wherein the body of the manifold unit comprises two or more separable parts, and wherein the coolant flow path extends through each separable part of the body of the manifold unit.

5. The fuel supply apparatus of claim 1, wherein the body of the manifold unit is substantially of a metallic material preferably wherein the body of the manifold unit is substantially of aluminium or preferably wherein the body of the manifold unit is substantially of stainless steel.

6. The fuel supply apparatus of claim 1, wherein the fuel supply apparatus comprises a first valve for controlling flow of the fuel supply flow path, and a second valve for controlling flow of the fuel recirculation flow path.

7. The fuel supply apparatus of claim 6, wherein the first valve and the second valve are integral to one another.

8. The fuel supply apparatus of claim 1, wherein the fuel supply apparatus comprises a first ejector for introducing recirculated fuel from the fuel recirculation flow path to the fuel supply flow path.

9. The fuel supply apparatus of claim 1, wherein the fuel supply flow path comprises a first branch, and a second branch arranged in parallel to the first branch,
wherein the fuel recirculation flow path comprises a respective first branch and a respective second branch,
wherein the fuel supply apparatus comprises a first ejector for introducing recirculated fuel from the respective first branch of the fuel recirculation flow path to the first branch of the fuel supply flow path,
a second ejector for introducing recirculated fuel from the respective second branch of the fuel recirculation flow path to the second branch of the fuel supply flow path, and
a first valve for controlling flow at the second branch of the fuel supply flow path, and a second valve for controlling flow at the respective second branch of the fuel recirculation flow path.

10. The fuel supply apparatus of claim 9, wherein the first valve and the second valve each have a first, closed position where flow is prevented and a second, open position where flow is permitted,
wherein, when said fuel cell system is operated at a first, lower, power rate, the first valve and the second valve are in the first, closed position, such that introduction of recirculated fuel to the second branch of the fuel supply flow path at the second ejector is prevented, and
when said fuel cell system is operated at a second, higher, power rate, the first valve and the second valve are in the second, open position, such that recirculated fuel is introduced to the second branch of the fuel supply flow path at the second ejector.

11. The fuel supply apparatus of claim 1, wherein the fuel supply flow path comprises a proportional valve, and wherein the proportional valve is integral to the body of the manifold unit preferably further comprising a control system, wherein the control system is configured to provide closed loop control of the proportional valve.

12. The fuel supply apparatus of claim 9, wherein the fuel supply flow path comprises a third branch arranged in parallel to the first branch and the second branch, wherein the fuel recirculation flow path comprises a respective third branch, and wherein the fuel supply apparatus further comprises:
a third ejector for introducing recirculated fuel from the respective third branch of the fuel recirculation flow path to the third branch of the fuel supply flow path; and
a third valve for controlling flow at the third branch of the fuel supply flow path, and a fourth valve for controlling flow at the respective third branch of the fuel recirculation flow path, wherein the third valve and the fourth valve each have a first, closed position where flow is prevented and a second, open position where flow is permitted,
wherein, when said fuel cell system is operated at the first, lower, power rate, the third valve and the fourth valve are in the first, closed position, such that introduction of recirculated fuel to the third branch of the fuel supply flow path at the third ejector is prevented,
when said fuel cell system is operated at the second, higher, power rate, the third valve and the fourth valve are in the first, closed position, such that the introduction of recirculated fuel to the third branch of the fuel supply flow path at the third ejector is prevented, and
when said fuel cell system is operated at a third power rate, higher than the first power rate, the third valve and the fourth valve are in the second, open position, such that recirculated fuel is introduced to the third branch of the fuel supply flow path at the third ejector.

13. The fuel supply apparatus of claim 1, wherein the or each valve is one of a non-return valve and a 2/2-way valve.

14. The fuel supply apparatus of claim 1, further comprising a valve for controlling flow at the respective first branch of the fuel recirculation flow path, preferably wherein the valve for controlling flow at the respective first branch of the fuel recirculation flow path is a non-return valve.

15. A fuel cell system comprising a fuel cell stack and the fuel supply apparatus of claim 1.

16. The fuel cell system of claim 15, further comprising a heating system for heating the fuel cell stack, wherein the heating system comprises a heat source, and wherein the heating apparatus is configured to obtain heat from the heat source.

17. The fuel cell system of claim 15, wherein the heating system comprises a first coolant flow path, wherein the heating apparatus comprises a second coolant flow path, and wherein the second coolant flow path is in fluid communication with the first coolant flow path.
